(19) United States
(12) Patent Application Publication
(10) Pub. No.: US 2004/0155055 A1
(43) Pub. Date: Aug. 12, 2004

(54) SYSTEM FOR SUPPLY OF A PRESSURIZED GAS AND METHOD FOR VERIFYING THAT A COMPRESSOR IS ACTIVE IN A SYSTEM FOR SUPPLY OF A PRESSURIZED GAS

(75) Inventors: Soren Bystedt, Goteborg (SE); Mats Sabelstrom, Billdal (SE)

Correspondence Address: TRACY W. DRUCE, ESQ., 1496 EVANS FARM DR, MCLEAN, VA, 22101, US

(73) Assignee: VOLVO LASTVAGNAR AB, Goteborg (SE)

(21) Appl. No.: 10/707,332

(22) Filed: Dec. 5, 2003

Related U.S. Application Data
(63) Continuation of application No. PCT/SE02/01071, filed on Jun. 4, 2002.

(30) Foreign Application Priority Data
Jun. 5, 2001 (SE) 0101949-6

(51) Int. Cl. B67D 5/00

(52) U.S. Cl. 222/3

(57) ABSTRACT

System for supply of compressed gas including one or more pressure tanks (6), a compressor (2) which can be controlled via first control member (7) and is arranged to supply the pressure tank or pressure tanks (6) with compressed gas, where the first control member (7) is arranged to adopt an active position when the compressor (2) is controlled to operate. Compressed gas is delivered to the pressure tanks, and a passive position when the compressor (2) is controlled not to operate.

### CROSS REFERENCE TO RELATED APPLICATIONS

The present application is a continuation patent application of International Application No. PCT/SE02/01071 filed 4 Jun. 2002 which was published in English pursuant to Article 21(2) of the Patent Cooperation Treaty, and which claims priority to Swedish Application No. 0101949-6 filed 5 Jun. 2001. Both applications are expressly incorporated herein by reference in their entireties.

### BACKGROUND OF INVENTION

1. Technical Field

The present invention relates to a system for supplying compressed gas comprising (including, but not limited to) one or more pressure tanks and a compressor that can be controlled, via a first control member, and which is arranged to supply a pressure tank(s) with compressed gas. The first control member is arranged to adopt an active state when the compressor is controlled to operate and deliver compressed gas to the pressure tank(s) and a passive state when the compressor is controlled to not operate. The invention also relates to a corresponding method for verifying the operating state of such a compressor.

2. Background

Systems for supplying compressed gas generally comprise a compressor, compressed-air lines and one or more compressed-air tanks which are fed by the compressor. The compressor is usually controlled by a first control member that is arranged to set the compressor to a first, active state when the compressor is operating, i.e. feeding compressed gas to the compressed-air tanks, and to a second, passive state when the compressor is not operating. In known designs, for example as shown in U.S. Pat. No. 4,863,355, the first control member is connected to a pressure sensor connected to the tanks, the first control member setting the compressor to an active or inactive state depending on the pressure measured by the pressure sensor.

Such known systems, however, lack the possibility to verify whether or not the compressor is actually supplying the compressed-air tanks in the system. This means that knowledge of whether the compressor is or is not in working order cannot be gained from the control system since it only sends a signal causing activation of the compressor, and thereafter is oblivious (ignores) whether compressed gas is being delivered to the pressure tanks or not.

### SUMMARY OF INVENTION

An object of the present invention is to provide a system for supplying compressed gas in which it is possible to verify whether the compressor of the system is delivering (or not) compressed gas to pressure tanks included in the system. This object is achieved by means of the first control member as described hereinabove regarding the inventive system. By virtue of the fact that the system also comprises a second control member, connected in signaling terms to a pressure sensor and arranged in the pressure tanks, that is configured to establish whether the compressor is operating (pumping air) because not only is tank pressure measured (recorded) by the pressure sensor, but so are changes in pressure in the pressure tank. From this information, it is possible to verify whether compressed gas is actually being delivered to the pressure tanks. According to a preferred embodiment of the invention, this information (knowledge) can be used to control a system for cooling the compressed air. According to a second embodiment, this knowledge can also be used to provide information on whether the compressor is in working order, by comparing control instructions from the first control member and the second control member, with function errors being found when the first control member indicates that the compressor is active and the second control member indicates that the compressor is passive, or vice versa. According to a third embodiment, this knowledge can also be used as information for preventive maintenance for replacing desiccant cartridges in air driers and/or replacing compressors.

### BRIEF DESCRIPTION OF DRAWINGS

The invention will be described in greater detail below with reference to the attached figures, in which:

FIG. 1 is a diagrammatic view showing a representation of a system for supply of compressed gas configured according to the teachings of the present invention;

FIG. 2 is a flow chart that diagrammatically represents a method for establishing whether or not a compressor in a system for supply of compressed gas is, or is not operating;

FIG. 3 is a diagrammatic view showing a representation of a system for cooling compressed air, by fan control, in a system for supply of compressed gas according to the present invention;

FIG. 4 is a flow chart that diagrammatically represents a method for establishing cooling requirements; and

FIG. 5 is a flow chart that diagrammatically represents an alternative method for establishing cooling requirements.

### DETAILED DESCRIPTION

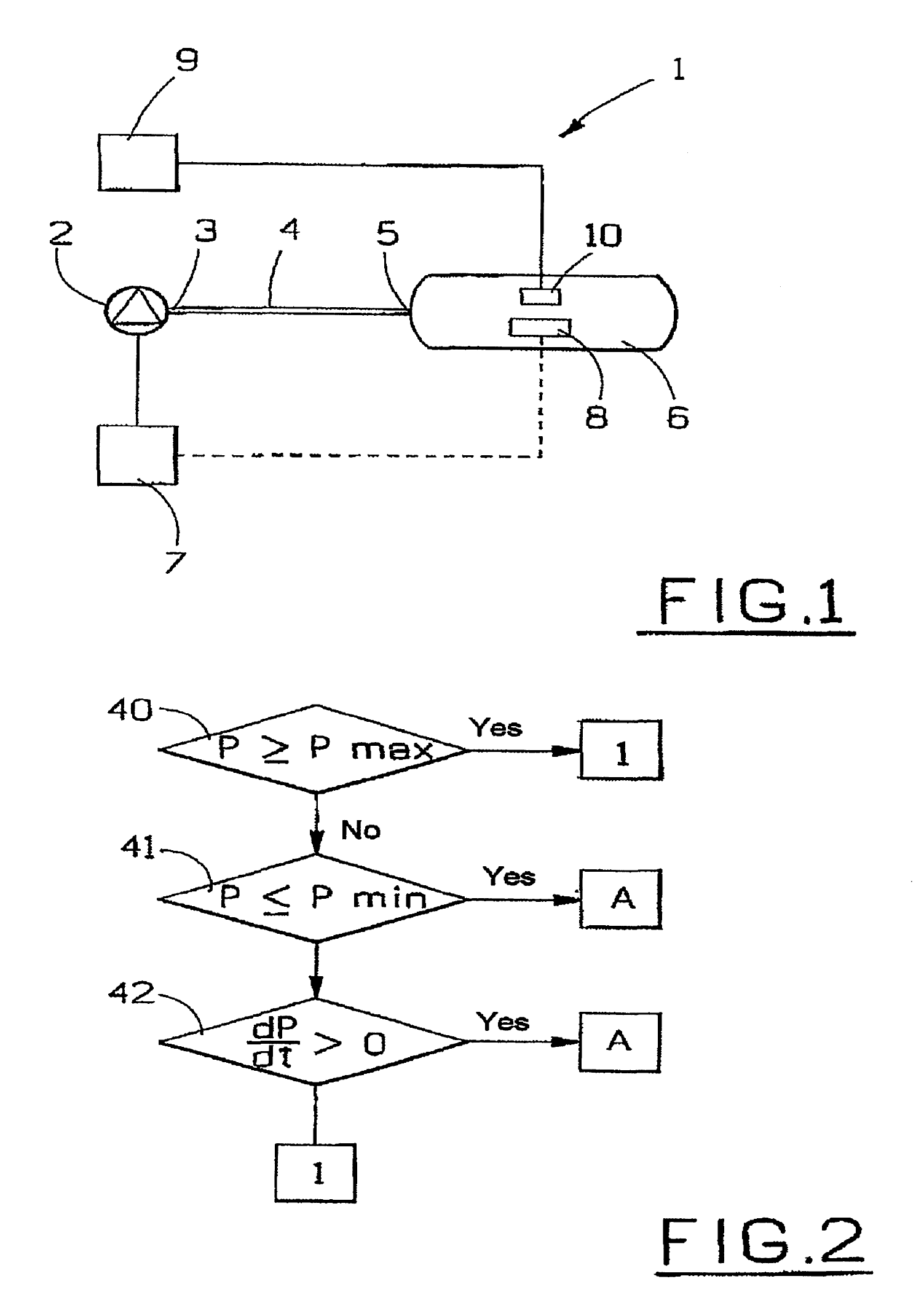

FIG. 1 is a diagrammatic representation of a system for supply of compressed gas. The system comprises a compressor 2 which is of a conventional type and will therefore not be described in greater detail herein. The compressor 2 has an outlet port 3 to which a gas line 4 is coupled. The compressed-air line connects the outlet port 3 to the inlet port 5 to one or more pressure tanks 6. Between the outlet port of the compressor 2 and the inlet port 5 of the pressure tank or pressure tanks 6, it is possible for one or more active components to be connected; for example, an air drier. The system further comprises a first control member 7 which is arranged to control the compressor 6 in a conventional manner. The first control unit is of a conventional type and will therefore not be described in any more detail here; it can, for example, be designed as is described in any of the following documents Japanese Utility Model Public Disclosure No. 59-14891 (1984), Japanese Patent Laid-Open No. 158392 (1984) or U.S. Pat. No. 4,863,355 each of which is expressly incorporated herein by reference. As is indicated in FIG. 1, the first control member can therefore be connected to a pressure sensor 8 arranged on the pressure tank(s) 6.

The first control member 7 is thus arranged to adopt an active position when the compressor is controlled to operate whereby compressed gas is delivered to the pressure tanks, and a passive position when the compressor is controlled not to operate. The compressor 2 is thus designed, on the one hand, to operate in an active operational mode when the compressor is supplying the compressed-air system with compressed air. On the other hand, the compressor 2 is designed to be disengaged or inactive when the compressor is not supplying the system. This can be achieved in a number of ways well known to the skilled person. According to one embodiment of the invention, a valve can be opened between cylinder spaces located in the compressor, the volumetric efficiency of the compressor thus falling and the compressor in this state being unable to generate compressed air with a pressure exceeding the system pressure. According to a second embodiment, a valve connecting the cylinder spaces of the compressor to the surrounding atmosphere is opened. A third possibility is to drive the compressor via a disengageable transmission.

The system further comprises a second control member 9 which is connected (in signaling terms) to a pressure sensor 10 arranged in the pressure tank(s) 6. The pressure sensor 10 can consist of the pressure sensor which is used for the first control member or, alternatively, it can be a separate pressure sensor. In a preferred embodiment, a separate pressure sensor is used, which increases the reliability of the verification of whether or not there are errors in the system.

The second control member 9 is arranged to establish that the compressor is operating by means of the pressure recorded by the pressure sensor and the changes in pressure in the pressure tank, as will be described below.

The second control member, without actually generating control signals to the compressor, thus establishes that the latter is operating by virtue of a pressure sensor 10, which is mounted in the pressure tank, and that is recording the pressure and pressure changes in the pressure tank 6. This is achieved by the fact that the second control member 9 establishes that the compressor 2 is operating when the pressure sensor 10 records a pressure in the pressure tank 6 below a first limit value. The second control member 9 establishes that the compressor is not operating when the pressure sensor 10 records a pressure in the pressure tank 6 above a second limit value. The second control member 9 establishes that the compressor 2 is operating when the pressure sensor 10 records a pressure in the pressure tank 6 between the first and second limit values and the sensor 10 records that the pressure is rising. The second control member 9 establishes that the compressor 2 is not operating when the pressure sensor 10 records a pressure in the pressure tank 6 between the first and second limit values and the sensor records that the pressure is dropping or is constant. According to one embodiment of the invention, the control member is also arranged to establish that there is a risk of a function error if the pressure does not rise above a lower limit value and that an error exists if the pressure rises above an upper limit value.

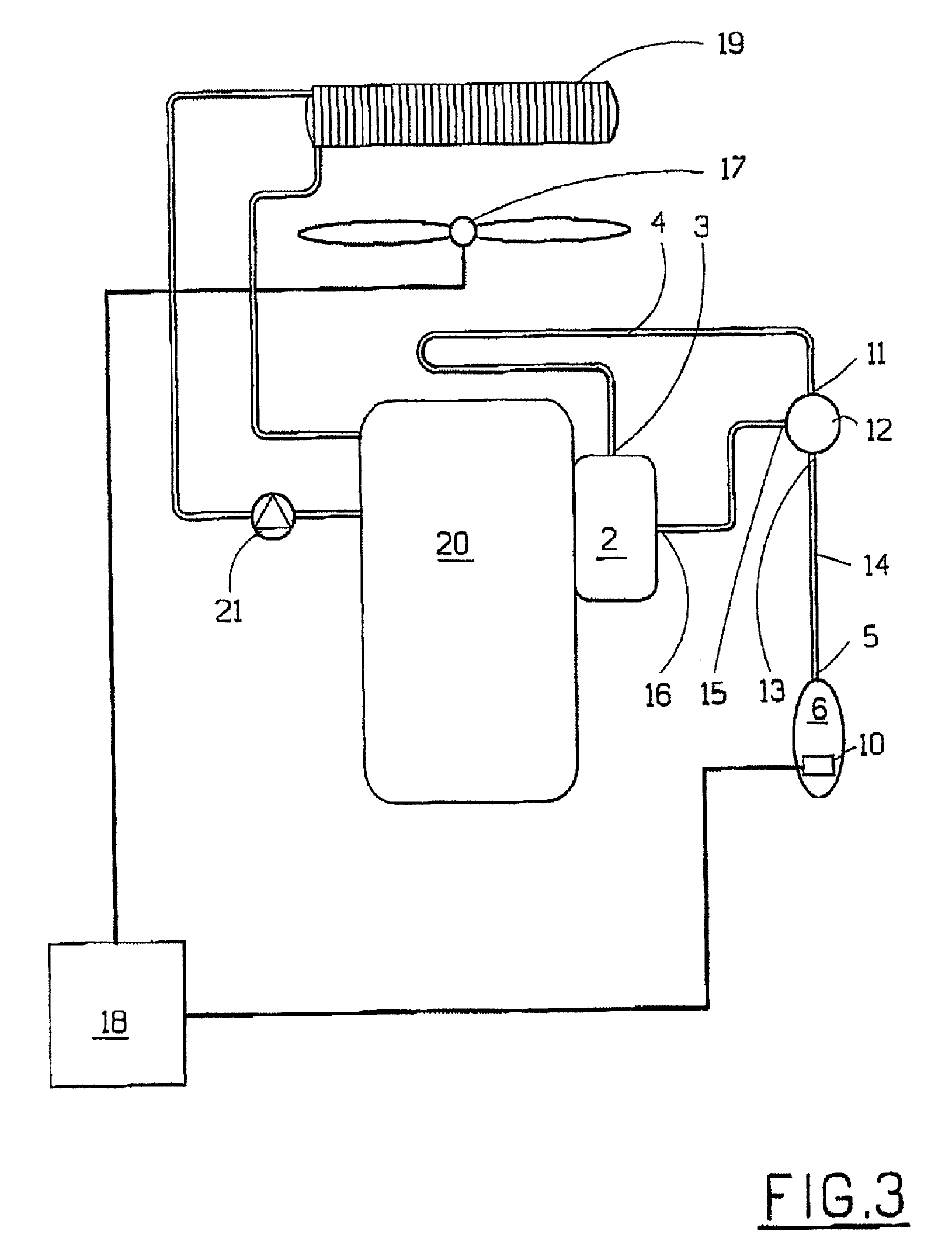

FIG. 2 is a diagrammatic representation of a method of determining whether the compressor 2 is, or is not driven in an active position when the compressor is feeding air to a pressure tank 6. A first step 40 determines whether the pressure in the pressure tank is above a first limit value, Pₘₐₓ. If such is the case, the compressor is inactive. A second step 41 determines if the pressure is below a second limit value, Pₘᵢₙ. If such is the case, the compressor is active. In a third step 42, it is noted if the pressure in the tank is rising. If such is the case, the compressor is active. Otherwise, the compressor is inactive.

FIG. 3 is a diagrammatic representation of a system for cooling compressed air by means of fan control, with a system for supply of compressed gas according to the invention being used. The system comprises a compressor 2 which is of a conventional type and will therefore not be described in any detail here. The compressor 2 has an outlet port 3 to which a compressed-air line 4 is coupled. The compressed-air line connects the outlet port to an inlet port 11 of a first active component 12. The first active component 12 preferably consists of an air drier. The air drier 12 also has a first outlet port 13 to which a second compressed-air line 14 is connected. The second compressed-air line 14 connects the air drier 12 to an inlet port 5 of a pressure tank 6. The pressure tank 6 thereafter supplies a set of air consumers (not shown). In an alternative embodiment, the first active component consists of a circuit distribution valve, which divides the compressed-air system into two or more separate circuits. The system for supply of compressed air can also include more than one pressure tank. In the illustrative embodiment shown, the air drier 12 also has a second outlet port 15 which, via a third compressed-air line 16, is connected to the disengagement mechanism of the compressor 2 and operates as a means of communicating a pneumatic signal to the disengagement mechanism.

The system for supply of compressed air also has a controllable fan 17. The fan is controlled by a control unit 18. The control of the fan 17 is such that the fan 17 can at least be turned on and off, alternatively the control can be such that the speed of rotation of the fan can be controlled. According to one embodiment of the invention, the fan 17 is driven by a speed-regulated electric motor, but it can also be mechanically coupled via a variable transmission to a motor of another type, for example a combustion engine 20. The variable transmission can be designed in known manner to the skilled person; for example the speed of rotation can be controlled via a viscose clutch that connects a power outlet from the motor 20 to the axis of rotation of the fan 17.

In the illustrative embodiment shown in FIG. 3, the fan 17 is a controllable fan that is included in the cooling system of the combustion engine 20. The cooling system comprises a set of cooling channels (not shown) arranged inside the combustion engine, inlet and outlet channels 18 which lead the coolant fluid from the combustion engine 20 to a radiator 19. The cooling system also generally comprises a pump 21 mounted in an inlet channel. The fan 17 is preferably mounted downstream of the cooler 19, which means that, if the system is mounted on a vehicle, the oncoming wind exerts a cooling effect on the radiator 19.

The compressed-air line 4, which connects the compressor 2 to the first active component 12, is placed so that it extends past the stream of air generated by the fan 17. This means that the fan is able to cool the air compressed by the compressor, and thus heated, before the heated air reaches the first active component 12. The compressed-air line 4 is preferably placed in such a way that it has a continuously falling path between the outlet port 3 of the compressor and the inlet port 11 of the first active component. This means that there are no pockets in which water can gather, and in this way the formation of ice plugs is avoided in cold weather. In the present context, continuously falling path is intended to signify that, when mounted on a flat base, the perpendicular distance between the flat base and the line decreases along the path from the outlet port 3 to the inlet port 11.

The control unit 18 is further arranged to establish cooling requirements for the compressed air delivered by the compressor 2 and to generate an activation signal for the controllable fan 17 when there is a cooling requirement, the first active component being protected from thermal overload by compressed air fed from the compressor.

The cooling requirement for the compressed-air line is calculated from information concerning the operational status of the compressor 2. This information includes information on whether the compressor is active or not; wherein active is taken top mean that the compressor is supplying the compressed-air system with air. Information on the speed of rotation of the compressor is also used since the temperature of the compressed air rises with increased speed of rotation.

The compressor 2 is thus designed, on the one hand, to operate in an active operating mode in which the compressor supplies the compressed-air system with compressed air. On the other hand, to be disengaged or inactive when the compressor is not supplying the system. This can be done in a number of ways well known to the skilled person. According to one embodiment, a valve can be opened between cylinder spaces located in the compressor, in which case the volumetric efficiency of the compressor decreases and the compressor in this state is unable to generate compressed air with a pressure which is above the system pressure. According to a second embodiment, a valve connecting the cylinder spaces of the compressor to the surrounding atmosphere is opened. A third possibility is to drive the compressor via a disengageable transmission.

The control unit 18 comprises a second control member 9 in accordance with what has been described above, which, without actually generating control signals to the compressor, establishes that the latter is operating by means of a pressure sensor 10, which is mounted in the pressure tank 6, recording the pressure and the changes in pressure in the pressure tank 6. This is achieved by the fact that the control unit establishes that the compressor is operating when the pressure sensor records a pressure in the pressure tank below a first limit value. The control unit establishes that the compressor is not operating when the pressure sensor records a pressure in the pressure tank above a second limit value. The control unit establishes that the compressor is operating when the pressure sensor records a pressure in the pressure tank between the first and second limit values and the sensor records that the pressure is rising. The control unit establishes that the compressor is not operating when the pressure sensor records a pressure in the pressure tank between the first and second limit values and the sensor records that the pressure is dropping or is constant.

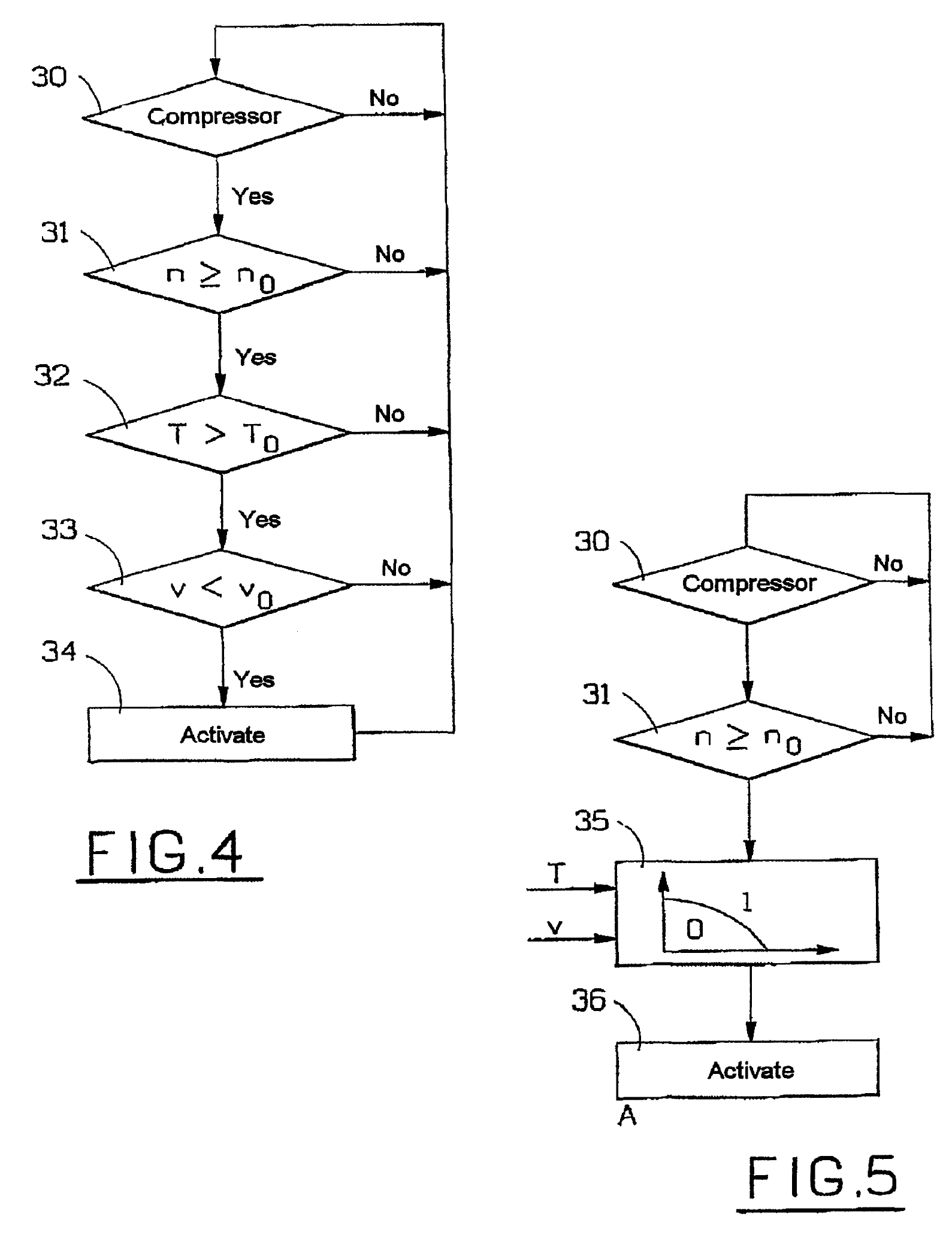

FIG. 4 is a diagrammatic representation (flow chart) of steps which, according to one embodiment of the invention, are gone through in order to establish whether or not there is a cooling requirement. A first method step 30 establishes whether the compressor 2 is, or is not feeding air to the system. If the compressor is not operating, there is no cooling requirement. A second step 31 determines whether the speed of rotation of the compressor exceeds a certain limit value. In one embodiment in which the compressor is driven by a combustion engine, the speed of rotation of the combustion engine is noted and cooling requirements may exist if the speed of rotation exceeds the idling speed of the combustion engine, which corresponds to a speed of about 700 rpm. A third step 32 determines whether the external temperature exceeds a certain limit value. A cooling requirement exists only if the external temperature exceeds this limit value. According to one embodiment, this limit value is set at 0° C. A fourth step 33 determines whether a vehicle in which the compressed-air system is mounted is being driven forwards at a speed in excess of a limit value. A cooling requirement exists only if the speed is below this limit value. According to one embodiment, the limit value is set at 50 km/h. When the checks according to steps one through to four have been carried out and the responses have been in the affirmative, the control unit, in a fifth step 34, generates an activation signal for the electrically controlled fan.

FIG. 5 shows an alternative embodiment for establishing whether or not there is a cooling requirement. A first method step 30 establishes whether the compressor 2 is or is not feeding air to the system. This can be established by one of the methods indicated above. If the compressor is not operating, there is no cooling requirement. A second step 31 determines whether the speed of rotation of the compressor exceeds a certain limit value. In one embodiment in which the compressor is driven by a combustion engine, the speed of rotation of the combustion engine is noted and cooling requirements may exist if the speed of rotation exceeds the idling speed of the combustion engine, which corresponds to a speed of about 700 rpm. In a third step 35, the parameters of external temperature T and vehicle speed are used as input data for a control function for the parameters of speed and external temperature. Depending on the combination of these two values, an output signal is generated which indicates whether or not there is a cooling requirement. In a fourth step 36, the control unit 18 generates an activation signal for the controllable fan if there is a cooling requirement.

The invention is not limited to the embodiments shown above, but instead can be varied within the scope of the patented claims.

1. A system for providing a supply of compressed gas, said system comprising:
a pressure tank;
a compressor, controllable via first control member, arranged to supply the pressure tank with compressed gas;
said first control member being arranged to adopt an active state when said compressor is controlled to operate and deliver compressed gas to the pressure tank and a passive state when the compressor is controlled not to operate;
a second control member signally connected to a pressure sensor arranged in the pressure tank and said second control member adapted to establish whether the compressor is operating by analysis of recorded pressure and pressure changes in the pressure tank.

2. The system as recited in claim 1, wherein said second control member is configured to establish that the compressor is operating when the pressure sensor records a pressure below a first limit value.

3. The system as recited in claim 1, wherein said second control member is configured to establish that the compressor is not operating when the pressure sensor records a pressure above a second limit value.

4. The system as recited in claim 3, wherein said second control member is configured to establish that the compressor is operating when the pressure sensor records a pressure between the first and second limit values and the sensor records that the pressure is rising, said second control member being further configured to establish that the compressor is not operating when the pressure sensor records a pressure between the first and second limit values and the sensor records that the pressure is dropping or is constant.

5. A method for verifying whether a compressor is operating in a system for supply of compressed gas, the system comprising a pressure tank, a compressor controllable via first control member and which is arranged to supply the pressure tank with compressed gas, the first control member is arranged to adopt an active state when the compressor is controlled to operate and whereby compressed gas is delivered to the pressure tank and a passive state when the compressor is controlled not to operate, a second control member is connected in, signaling terms, to a pressure sensor that records pressure, and changes in pressure, in the pressure tank; the method comprising:
utilizing the second control member, establishing that the compressor is operating when the pressure sensor records a pressure below a first limit value;
utilizing the second control member, establishing that the compressor is not operating when the pressure sensor records a pressure above a second limit value;
utilizing the second control member, establishing that the compressor is operating when the pressure sensor records a pressure between the first and second limit values and the sensor records that the pressure is rising, and
utilizing the second control member, establishing that the compressor is not operating when the pressure sensor records a pressure between the first and second limit values and the sensor records that the pressure is dropping or is constant.
